(19) United States
(12) Patent Application Publication
(10) Pub. No.: US 2021/0370981 A1
(43) Pub. Date: Dec. 2, 2021

(54) DRIVING ASSISTANCE DEVICE, DRIVING ASSISTANCE METHOD, AND RECORDING MEDIUM

(71) Applicant: NEC Corporation, Minato-ku, Tokyo (JP)

(72) Inventors: Kazuki INAGAKI, Tokyo (JP); Yuta SHIMIZU, Tokyo (JP)

(73) Assignee: NEC Corporation, Minato-ku, Tokyo (JP)

(21) Appl. No.: 17/277,095

(22) PCT Filed: Sep. 9, 2019
(86) PCT No.: PCT/JP2019/035348

§ 371 Date: Mar. 17, 2021

(30) Foreign Application Priority Data
Sep. 26, 2018 (JP) 2018-180463

(51) Int. Cl. B60W 60/00

(52) U.S. Cl. CPC B60W 60/0053; B60W 2540/225; B60W 2420/42; B60W 2552/53; B60W 2520/06

(57) ABSTRACT

A driving assistance device includes: a movement destination detection unit that detects a movement destination direction of a mobile body; a line-of-sight direction detection unit that detects a line-of-sight direction of a driver of the mobile body; and a driving mode control unit that permits a change from an autonomous driving mode to a manual driving mode when an angle based on the movement destination direction and the line-of-sight direction is within a predetermined range.

### TECHNICAL FIELD

The present invention relates to a driving assistance device, a driving assistance method, and a recording medium.

### BACKGROUND ART

In recent years, a speed of technological development is increasing due to the implementation of autonomous driving technology on mobile bodies such as automobiles. As one of the autonomous driving technologies, it is assumed that the autonomous driving can be switched to a manual driving. A related technology is disclosed in Patent Document 1.

Paragraph 0046 in Patent Document 1 discloses that the driving of a vehicle is switched from an autonomous driving to a manual driving.

### PRIOR ART DOCUMENTS

### Patent Document

[Patent Document 1] Japanese Unexamined Patent Application, First Publication

### SUMMARY OF THE INVENTION

### Problem to be Solved by the Invention

There is a demand for a technology that improves safety when switching between the autonomous driving and the manual driving described above.

An example object of the present invention is to provide a driving assistance device, a driving assistance method, and a recording medium that solve the problems described above.

### Means for Solving the Problem

According to a first example aspect of the present invention, a driving assistance device includes: a movement destination detection unit that detects a movement destination direction of a mobile body; a line-of-sight direction detection unit that detects a line-of-sight direction of a driver of the mobile body; and a driving mode control unit that permits a change from an autonomous driving mode to a manual driving mode when an angle based on the movement destination direction and the line-of-sight direction is within a predetermined range.

According to a second example aspect of the present invention, a driving assistance method includes: detecting a movement destination direction of a mobile body; detecting a line-of-sight direction of a driver of the mobile body; and permitting a change from an autonomous driving mode to a manual driving mode when an angle based on the movement destination direction and the line-of-sight direction is within a predetermined range.

According to a third example aspect of the present invention, a recording medium storing a program for causing a computer to execute: detecting a movement destination direction of a mobile body; detecting a line-of-sight direction of a driver of the mobile body; and permitting a change from an autonomous driving mode to a manual driving mode when the movement destination direction and the line-of-sight direction are within a predetermined range.

### Effect of the Invention

According to example embodiments of the present invention, it is possible to provide a technology that improves safety when switching between an autonomous driving and a manual driving.

### BRIEF DESCRIPTION OF THE DRAWINGS

FIG. 1 is a diagram showing an automobile equipped with a driving assistance device according to an example embodiment of the present invention.

FIG. 2 is a hardware configuration diagram of the driving assistance device according to the present example embodiment.

FIG. 3 is a functional block diagram of the driving assistance device according to the present example embodiment.

FIG. 4 is a diagram showing a processing flow of a driving assistance device according to the present example embodiment.

FIG. 5A is a first diagram for explaining details of the processing by the driving assistance device in the present example embodiment.

FIG. 5B is a first diagram for explaining details of the processing by the driving assistance device according to the present example embodiment.

FIG. 6 is a second diagram for explaining details of the processing by the driving assistance device according to the present example embodiment.

FIG. 7 is a diagram showing a configuration of a driving assistance device according to another example embodiment of the present invention.

### EXAMPLE EMBODIMENTS

Hereinafter, a driving assistance device 1 according to an example embodiment of the present invention will be described with reference to the drawings.

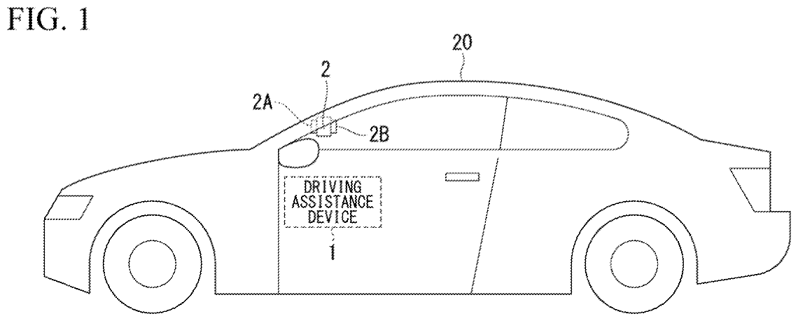

FIG. 1 shows an automobile equipped with the driving assistance device 1 according to the present example embodiment.

The driving assistance device 1 is mounted inside a mobile body such as an automobile 20. The mobile body may be any object other than the automobile 20 as long as it moves and carries persons. For example, the mobile body may be an aircraft, a ship, a motorcycle, or the like, in addition to the automobile 20.

A camera 2 is provided in the automobile 20. The camera 2 is connected to the driving assistance device 1 by wire or wireless communication. The camera 2 transmits a first captured image of a front road surface in the traveling direction outside of the automobile 20 captured based on the incident light on a lens 2A to the driving assistance device 1. In addition, the camera 2 transmits a second captured image of the driver's face inside the automobile 20 captured based on the incident light on a lens 2B to the driving assistance device 1.

In the present example embodiment, the camera 2 transmits each of the first captured image and the second captured image to the driving assistance device 1, but it is not limited to such a configuration. The automobile 20 may include a first camera that generates the first captured image by capturing an image in front of the traveling direction and a second camera that generates a second captured image by capturing an image of the driver's face. That is, the camera 2 in the present example embodiment has the functions of the first camera and the second camera.

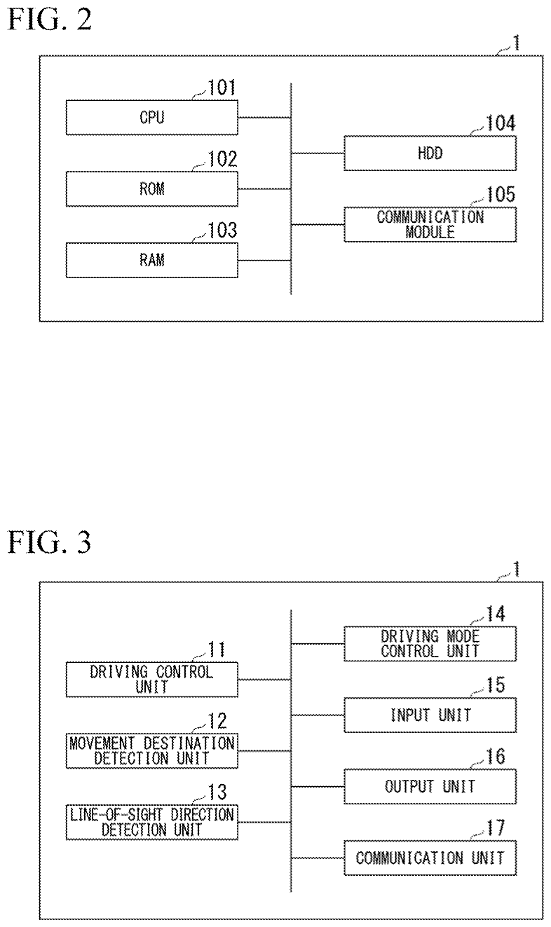

FIG. 2 is a hardware configuration diagram of the driving assistance device 1.

As illustrated in FIG. 2, the driving assistance device 1 is a computer including hardware such as a CPU (central processing unit) 101, a ROM (read only memory) 102, a RAM (random access memory) 103, a HDD (hard disk drive) 104, and a communication module 105.

FIG. 3 is a functional block diagram of the driving assistance device 1.

The driving assistance device 1 is activated when the power is turned on, and executes a driving assistance program stored in advance. As a result, the driving assistance device 1 can execute functions of a driving control unit 11, a movement destination detection unit 12, a line-of-sight direction detection unit 13, a driving mode control unit 14, an input unit 15, and an output unit 16.

The driving control unit 11 controls the driving control of the automobile 20 and controls other functional units of the driving assistance device 1. The movement destination detection unit 12 detects the movement destination direction of the automobile 20. The line-of-sight direction detection unit 13 detects the line-of-sight direction of a driver of the automobile 20. The driving mode control unit 14 permits a change from the autonomous driving mode to the manual driving mode when the movement destination direction and the line-of-sight direction are within a predetermined range. The input unit 15 receives user operations from a user interface. The output unit 16 outputs output information to a predetermined output device such as a monitor or a speaker. The communication unit 17 is communicably connected to the camera 2 and other external devices. Here, the autonomous driving mode may mean a mode in which the automobile 20 travels without the driver operating the steering wheel. The autonomous driving mode may mean a mode in which the automobile 20 travels without the driver operating an accelerator and a brake. The manual driving mode may mean a mode in which the automobile 20 travels when the driver operates the steering wheel. The manual driving mode may mean a mode in which the automobile 20 travels when the driver operates the accelerator and the brake.

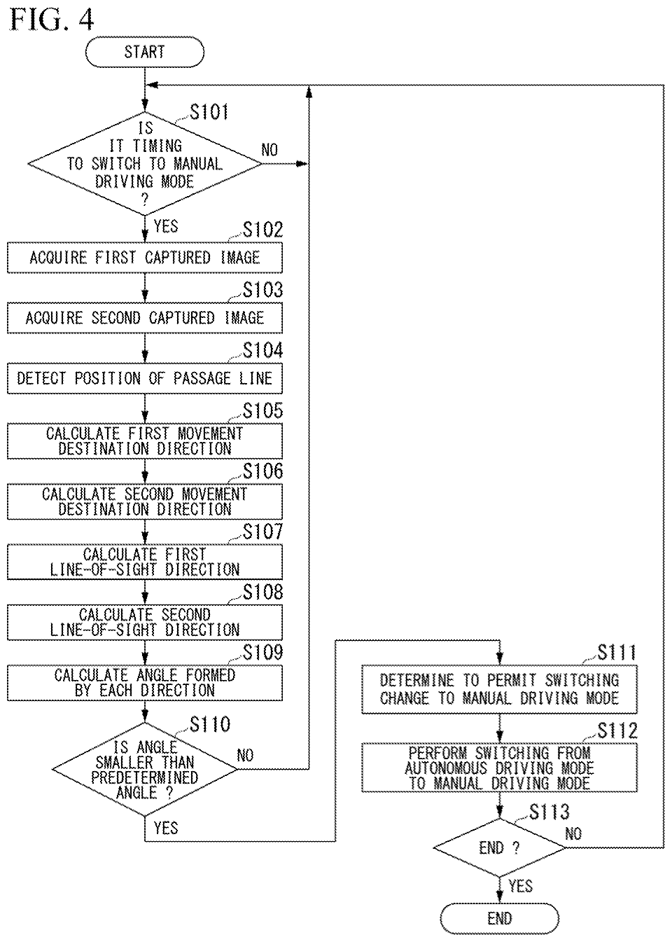

FIG. 4 illustrates the processing flow by the driving assistance device 1.

Next, the processing flow by the driving assistance device 1 will be described.

A case where the driving control unit 11 performs driving control in the autonomous driving mode of the automobile 20 based on the operation by the driver will be described. In this case, the driving control in the autonomous driving mode is a control to autonomously travels a path to the destination, for example, based on the first captured image obtained from the camera 2 by imaging the front of the traveling direction, the information (position information, speed, and the like) obtained from other sensors, and the map information stored in advance in the HDD or the like. A known technology may be used for the driving control in the autonomous driving mode.

The driving control unit 11 determines whether or not it is a timing to switch to the manual driving mode in a situation where the automobile 20 is in the autonomous driving mode (STEP S101). For example, the driving control unit 11 calculates a distance from the current latitude and longitude to the latitude and longitude of the destination. When it is determined that the calculated distance is within a predetermined distance (for example, 200 m) (that is, when it is determined that the distance from the automobile 20 to the destination is within a predetermined distance), the driving control unit 11 determines that it is the timing to switch to the manual driving mode. The driving control unit 11 may acquire the current latitude and longitude from GPS (global positioning system), GNSS (global navigation satellite system), or the like. The destination may be a driver's home or a predetermined parking lot. When a request for switching to the manual driving mode is acquired from the input unit 15 based on the user operation, the driving control unit 11 may determine that it is the timing to switch to the manual driving mode. When a notification of the approach of an emergency vehicle is received from an external device via the communication unit 17, the driving control unit 11 may determine that it is the timing to switch to the manual driving mode. When a signal indicating a failure transmitted from a predetermined sensor provided in the automobile 20 is detected, the driving control unit 11 may determine that it is the timing to switch to the manual driving mode. When a signal indicating an approach to a predetermined road such as a highway is detected from an external device, the driving control unit 11 may determine that it is the timing to switch to the manual driving mode.

When it is determined that it is the timing to switch from the autonomous driving mode to the manual driving mode, the driving control unit 11 instructs the movement destination detection unit 12, the line-of-sight direction detection unit 13, and the driving mode control unit 14 to start processing. The movement destination detection unit 12 acquires the first captured image obtained by imaging the road surface in front of the traveling direction received by the driving assistance device 1 from the camera 2 (STEP S102). In addition, the line-of-sight direction detection unit 13 acquires the second captured image obtained by imaging the driver's face received by the driving assistance device 1 from the camera 2 (STEP S103).

The movement destination detection unit 12 detects a position of the passage line (lane) shown in the first captured image (STEP S104). Then, as an example, the movement destination detection unit 12 calculates a first movement destination direction of a straight line connecting a center point of the passage line of the automobile 20 at a position in front of the automobile 20 and a center point of the passage line at the current position of the automobile 20 (STEP S105). The center point of the passage line at a position in front of the automobile 20 may be a center point between the passage line on the left side and the passage line on the right side of the automobile 20 at the position in front of the automobile 20 (the position in front of the current position of the automobile 20). The center point of the passage line at the current position of the automobile 20 may be a center point between the passage line on the left side and the passage line on the right side of the automobile 20 at the current position of the automobile 20. The movement destination direction obtained here indicates a vector of a first three-dimensional space with the lens 2A of the camera as the origin. The movement destination detection unit 12 calculates a second movement destination direction in which the movement destination direction is mapped on a horizontal plane of the first three-dimensional space (STEP S106). In this way, the movement destination detection unit 12 can detect the direction of the movement destination of the automobile 20. The movement destination detection unit 12 outputs the second movement destination direction to the driving mode control unit 14.

The line-of-sight direction detection unit 13 calculates a first line-of-sight direction based on a position of a pupil in the eyeball shown in the second captured image (STEP S107). A known technology may be used to detect the line-of-sight direction. The line-of-sight direction obtained here indicates a vector of a second three-dimensional space with the driver's pupil as the origin. The line-of-sight direction detection unit 13 calculates a second line-of-sight direction in which the first line-of-sight direction is mapped on the horizontal plane of the second three-dimensional space (STEP S108). In this way, the line-of-sight direction detection unit 13 can detect the direction of the driver's line-of-sight. The line-of-sight direction detection unit 13 outputs the second line-of-sight direction to the driving mode control unit 14.

The driving mode control unit 14 calculates an angle formed by each direction when the origins of the input second movement destination direction and the second line-of-sight direction are overlapped (STEP S109). The driving mode control unit 14 determines whether the angle formed by the second movement destination direction and the second line-of-sight direction is smaller than a predetermined angle (STEP S110). When the angle formed by the second movement destination direction and the second line-of-sight direction is smaller than the predetermined angle, the driving mode control unit 14 determines to permit the switching change from the autonomous driving mode to the manual driving mode (STEP S111). Then, the driving mode control unit 14 outputs an instruction to the driving control unit to stop the driving control in the autonomous driving mode and to switch the driving mode to the manual driving mode based on the permission of the change.

The driving control unit 11 acquires the instruction to switch the driving mode to the manual driving mode from the driving mode control unit 14. The driving control unit 11 performs the switching from the autonomous driving mode to the manual driving mode based on the instruction (STEP S112). After that, the automobile 20 operates based on the driving operation of the driver. The driving control unit 11 determines whether to end the processing (STEP S113). The driving control unit 11 repeats the processing from STEP S101 until it is determined that the processing is ended.

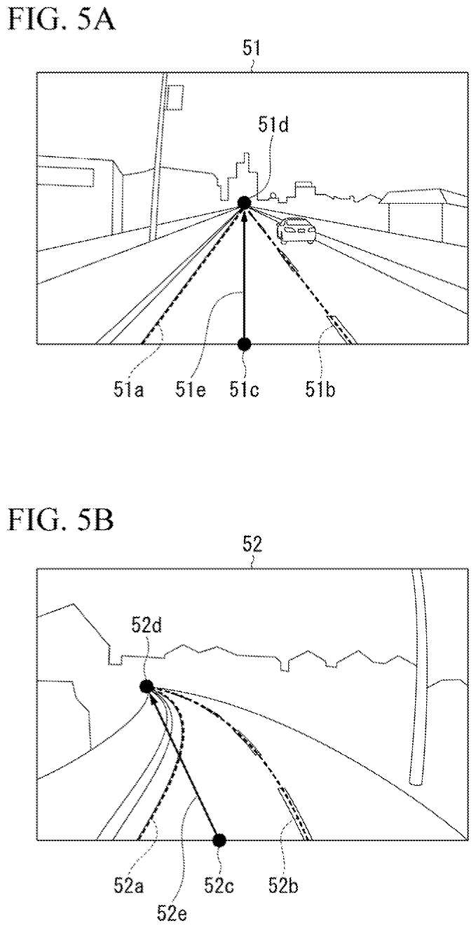

FIG. 5A and FIG. 5B are first diagrams for explaining details of the processing by the driving assistance device. FIG. 5A and FIG. 5B illustrate two first captured images. Specifically, FIG. 5A illustrates a first captured image 51 generated when a traveling road of the automobile 20 is a straight line. FIG. 5B illustrates a second captured image 52 generated when the traveling road is curved.

The movement destination detection unit 12 detects passage lines 51a and 51b from the first captured image 51 as described above. The movement destination detection unit 12 detects the passage lines 51a and 51b by detecting straight lines or curves in which white pixels are continuously indicated in the first captured image using an edge detection technology or the like. Then, the movement destination detection unit 12 calculates a position of a midpoint 51c of the lower end points of the left and right passage lines 51a and 51b and a position of a midpoint 51d of the upper ends of the passage lines 51a and 51b. The movement destination detection unit 12 calculates a straight line connecting the midpoints 51c and 51d. This straight line is a first movement destination direction 51e in the first captured image 51.

Similarly, the movement destination detection unit 12 detects passage lines 52a and 52b from the second captured image 52. The movement destination detection unit 12 detects the passage lines 52a and 52b by detecting straight lines or curves in which white pixels are continuously indicated in the second captured image 52 using the edge detection technology or the like. Then, the movement destination detection unit 12 calculates a position of a midpoint 52c at the lower end points of the left and right passage lines 52a and 52b and a position of the midpoint 52d at the upper ends of the passage lines 52a and 52b. The movement destination detection unit 12 calculates a straight line connecting the midpoints 52c and 52d. This straight line is a second movement destination direction 52e in the second captured image 52.

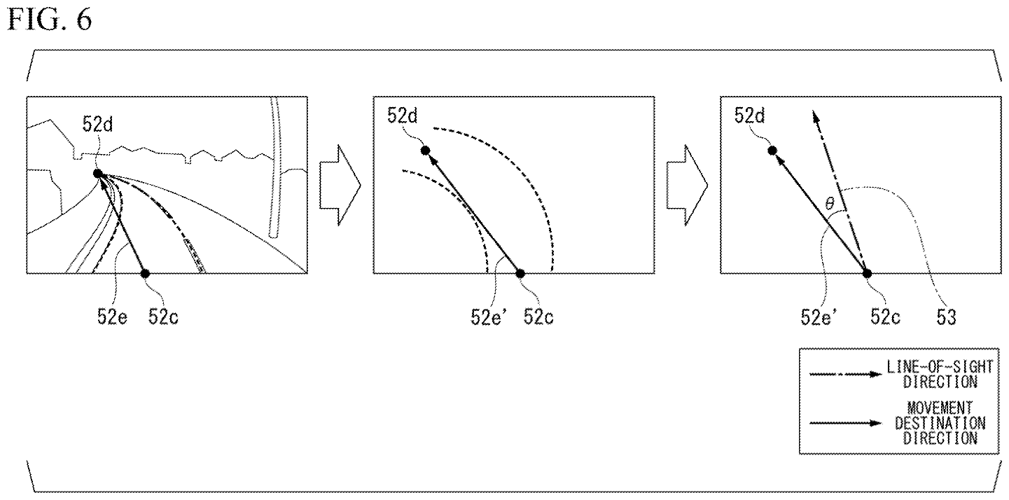

FIG. 6 is a second diagram for explaining details of the processing by the driving assistance device 1.

An example in which the processing proceeds using the second captured image 52 will be described with reference to FIG. 6. The movement destination detection unit 12 calculates the second movement destination direction 52e from the second captured image 52 using the method described with reference to FIGS. 5A and 5B. Next, the movement destination detection unit 12 calculates the second movement destination direction 52e′ in which the second movement destination direction 52e is mapped on the horizontal plane of the first three-dimensional space. The line-of-sight direction detection unit 13 calculates the second line-of-sight direction 53′ in which the first line-of-sight direction 53 is mapped on the horizontal plane of the second three-dimensional space. Then, the driving mode control unit 14 calculates an angle θ formed by each direction when the origins of the input second movement destination direction 52e′ and the second line-of-sight direction 53′ are overlapped. When the angle θ is smaller than a threshold value (for example, 30 degrees), the driving mode control unit 14 determines to permit the switching change from the autonomous driving mode to the manual driving mode.

Alternatively, the movement destination detection unit 12 may calculate the second movement destination direction using a method described below. That is, the movement destination detection unit 12 acquires map information stored in the driving assistance device 1 in advance. The movement destination detection unit 12 calculates a straight line on the map plane connecting the current position on the moving path of the automobile 20 included in the map information and the position of the movement destination indicating a predetermined distance ahead from the current position on the moving path. The movement destination detection unit 12 uses the calculated straight line as the second movement destination direction.

In addition, alternatively, the movement destination detection unit 12 may calculate the second movement destination direction using a method described below. That is, the movement destination detection unit 12 acquires road design information stored in the driving assistance device 1 in advance. The movement destination detection unit 12 calculates a straight line on the map plane connecting the current position on the moving path (road) of the automobile 20 included in the road design information and the position of the movement destination indicating a predetermined distance ahead from the current position on the moving path. The destination detection unit 12 uses the calculated straight line as the second movement destination direction. The road design information may be information that stores information such as the shoulder of the road and position information at the center of the lane.

The processing by the driving assistance device 1 in the present example embodiment has been described above. According to the processing described above, in the situation of the autonomous driving mode, if it is determined that it is the timing to switch to the manual driving mode, when the driver's line-of-sight is determined to be different from the movement destination direction based on the movement destination direction, it is possible to stop the driver driving manually. As a result, it is possible to improve safety at the time when switching between the autonomous driving and the manual driving.

The driving mode control unit 14 of the driving assistance device 1 may determine whether or not an angle of the current steering wheel of the automobile 20 corresponds to the second movement destination direction 52e′ in addition to the determination whether the angle 0 formed by the second movement destination direction 52e′ and the second line-of-sight direction 53′ is smaller than a predetermined threshold value. The driving mode control unit 14 may determine to permit the switching change from the autonomous driving mode to the manual driving mode when the movement direction of the automobile 20 set by the angle of the steering wheel is determined to be corresponding to the second movement destination direction 52e′ based on the result of determination of the angle of the steering wheel.

In the processing described above, the driving mode control unit 14 may determine whether a vertical component (magnitude in the vertical vector direction) of the first line-of-sight direction is equal to or greater than a predetermined threshold value. When the vertical component of the first line-of-sight direction is equal to or greater than the predetermined threshold value, the driving mode control unit 14 may determine that the driver's line-of-sight is facing upward or downward, and may determine not to permit the switching change from the autonomous driving mode to the manual driving mode.

In the processing described above, when there is an area where an accident rate is high such as an intersection or a crossing between the current position of the automobile 20 and a position determined to be close to the automobile 20 on a predetermined path, the driving mode control unit 14 may determine not to permit the switching change from the autonomous driving mode to the manual driving mode.

In the processing described above, when the second movement destination direction cannot be acquired from the movement destination detection unit 12, the driving mode control unit 14 may determine not to permit the switching change from the autonomous driving mode to the manual driving mode. The case where the second movement destination direction cannot be acquired is, for example, a case where an obstacle or another vehicle is positioned in front of the automobile 20 in close proximity.

In the processing described above, the driving assistance device 1 may add or subtract a safe driving score based on a transition of the angle 0 between the second movement destination direction 52e′ and the second line-of-sight direction 53′ according to an elapsed time. If the time of the formed angle θ is long, the score is subtracted, and if it is short, the score is added.

In the processing described above, the line-of-sight direction detection unit 13 calculates the line-of-sight direction based on the position of the pupil in the eyeball, but not limited to such a case. The line-of-sight direction detection unit 13 may calculate the line-of-sight direction using also the direction in which the face is facing.

When the mobile body is an aircraft or a ship, since the mobile body does not travel on the road surface, there is no passage line in the captured image. In this case, the driving assistance device 1 may detect the movement destination direction in the three-dimensional space based on the operation instruction of the aircraft or the ship, and if the movement destination direction and the line-of-sight direction are within a predetermined range when comparing the movement destination direction and the line-of-sight direction, the driving assistance device 1 may permit the change from the autonomous driving mode to the manual driving mode.

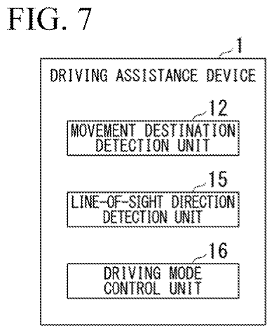

FIG. 7 is a diagram showing a configuration of a driving assistance device according to another example embodiment of the present invention.

As illustrated in FIG. 7, a driving assistance device 1 includes at least a movement destination detection unit 12, a line-of-sight direction detection unit 13, and a driving mode control unit 14. The movement destination detection unit 12 detects a movement destination direction of a mobile body (automobile 20).

The line-of-sight direction detection unit 13 detects the line-of-sight direction of the driver of the mobile body.

The driving mode control unit 14 permits a change from the autonomous driving mode to the manual driving mode when the movement destination direction and the line-of-sight direction are within a predetermined range.

The driving assistance device 1 described above has a computer system inside. The procedure of each processing described above is stored in a computer-readable recording medium in a form of a program, and the processing described above is performed by the computer reading and executing the program.

The program described above may be a program for realizing a part of the functions described above. Furthermore, the program described above may be a so-called difference file (difference program) that can realize the functions described above in combination with a program already recorded in the computer system.

This application is based upon and claims the benefit of priority from Japanese Patent Application No. 2018-180463, filed Sep. 26, 2018, the disclosure of which is incorporated herein in its entirety.

### INDUSTRIAL APPLICABILITY

The present invention may be applied to a driving assistance device, a driving assistance method, and a recording medium.

### REFERENCE SYMBOLS

1: Driving assistance device

2: Camera

11: Driving control unit

12: Movement destination detection unit

13: Line-of-sight direction detection unit

14: Driving mode control unit

15: Input unit

16: Output unit

17: Communication unit

What is claimed is:

1. A driving assistance device comprising:
at least one memory configured to store instructions; and
at least one processor configured execute the instructions to:
detect a movement destination direction of a mobile body;
detect a line-of-sight direction of a driver of the mobile body; and
permit a change from an autonomous driving mode to a manual driving mode when an angle based on the movement destination direction and the line-of-sight direction is within a predetermined range.

2. The driving assistance device according to claim 1, wherein the at least one processor is configured execute the instructions to:
set a mode of the mobile body to the manual driving mode when the change is permitted.

3. The driving assistance device according to claim 1, wherein detecting the movement destination direction includes detecting the movement destination direction based on a line connecting a center point of passage lines provided on both sides of a road surface at a current position of the mobile body and a center point of passage lines provided on both sides of the road surface at a position in front of the current position of the mobile body.

4. The driving assistance device according to claim 3, wherein detecting the movement destination direction includes acquiring a first image showing a passage line in front of the mobile body, and detecting a position of the passage line shown in the first image.

5. The driving assistance device according to claim 1 wherein detecting the movement destination direction includes detecting the movement destination direction based on a current position of the mobile body on a moving path included in map information and a position in front of the current position on the moving path.

6. The driving assistance device according to claim 1, wherein detecting the movement destination direction includes detecting the movement destination direction based on a current position of the mobile body on a moving path included in road design information and a position in front of the current position on the moving path.

7. The driving assistance device according to claim 1, wherein detecting the line-of-sight direction includes acquiring a second image showing a face of the driver of the mobile body, and detecting the line-of-sight direction based on a position of a pupil in an eyeball shown in the second image.

8. The driving assistance device according to claim 1, wherein permitting the change includes permitting the change when an angle based on a direction obtained by mapping the movement destination direction and the line-of-sight direction on a horizontal plane is within a predetermined range.

9. A driving assistance method comprising:
detecting a movement destination direction of a mobile body;
detecting a line-of-sight direction of a driver of the mobile body; and
permitting a change from an autonomous driving mode to a manual driving mode when an angle based on the movement destination direction and the line-of-sight direction is within a predetermined range.

10. A non-transitory recording medium storing a program for causing a computer to execute:
detecting a movement destination direction of a mobile body;
detecting a line-of-sight direction of a driver of the mobile body; and
permitting a change from an autonomous driving mode to a manual driving mode when an angle based on the movement destination direction and the line-of-sight direction is within a predetermined range.
